(19) United States
(12) Patent Application Publication
(10) Pub. No.: US 2011/0199498 A1
(43) Pub. Date: Aug. 18, 2011

(54) Image pickup apparatus

(76) Inventors: Yoshinori Matsuzawa, Tokyo (JP); Osamu Nonaka, Sagamihara-shi (JP)

(21) Appl. No.: 13/027,972

(22) Filed: Feb. 15, 2011

(30) Foreign Application Priority Data
Feb. 16, 2010 (JP) 2010-31566

(51) Int. Cl. H04N 5/262; H04N 5/225

(52) U.S. Cl. 348/220.1; 348/240.2; 348/E05.055; 348/E05.024

(57) ABSTRACT

An image pickup apparatus is provided to which a first lens capable of motorized zooming and a second lens that is not capable of motorized zooming can be detachably mounted. The image pickup apparatus includes: a first operation section for controlling zoom processing; and a control section that, when the first lens is mounted, conducts optical zoom processing that controls a zoom lens of the first lens based on an operation of the first operation section, and when the second lens is mounted, conducts electronic zoom control that changes a cut-out range of a picked-up image based on an operation of the first operation section.

This application claims benefit of Japanese Application No. 2010-31566 filed in Japan on Feb. 16, 2010, the contents of which are incorporated by this reference.

### BACKGROUND OF THE INVENTION

1. Field of the Invention

The present invention relates to a photographing apparatus with respect to which a plurality of interchangeable lenses are selectively attached and detached to allow a user to enjoy various kinds of photographing with the most suitable lens.

2. Description of Related Art

Recently, photographic devices such as digital cameras have taken advantage of electronic control to overcome problems relating to various photographing scenes which heretofore the devices have been unable to photograph well, and have enabled photographing of not just still images but also of moving images of such scenes.

Further, in the field of digital single-lens reflex cameras, cameras are being configured so that interchangeable lenses and accessories can be systematically attached and detached thereto or expanded to correspond to various scenes.

For example, Japanese Patent Application Laid-Open Publication No. 2005-311783 (hereunder, referred to as “Document 1”) discloses technology that sends head information from a camera head to a camera body, and rewrites processing variables and the like in the camera body. According to the invention described in Document 1, when a camera head that includes a fixed focal length lens is mounted to a camera body, electronic zoom is performed in accordance with a zooming operation carried out using cross keys provided on the camera body.

### SUMMARY OF THE INVENTION

An image pickup apparatus according to a first aspect of the present invention is an image pickup apparatus to which a first lens capable of motorized zooming and a second lens that is not capable of motorized zooming can be detachably mounted, which includes: a first operation section for controlling zoom processing; and a control section that, when the first lens is mounted, conducts optical zoom processing that controls a zoom lens of the first lens based on an operation of the first operation section, and when the second lens is mounted, conducts electronic zoom control that changes a cut-out range of a picked-up image based on an operation of the first operation section.

An image pickup apparatus according to another aspect of the present invention is an image pickup apparatus to which a first lens that has a second operation section for controlling a zoom lens and that is capable of motorized zooming can be detachably mounted, which includes: a first operation section for controlling zoom processing; and a control section that, when moving image photographing is not being performed, conducts optical zoom processing that controls the zoom lens based on an operation of the second operation section and conducts electronic zoom control that changes a cut-out range of a picked-up image based on an operation of the first operation section, and when moving image photographing is being performed, disregards an operation of the second operation section and conducts optical zoom processing that controls the zoom lens based on an operation of the first operation section.

An image pickup apparatus according to a further aspect of the present invention is an image pickup apparatus to which a fixed focal length lens that has a focusing operation section for controlling a focus lens can be detachably mounted, which includes: a first operation section for controlling zoom processing; and a control section that, when moving image photographing is not being performed, conducts electronic zoom control that changes a cut-out range of a picked-up image based on an operation of the first operation section and conducts focus control that controls the focus lens based on an operation of the focusing operation section, and when moving image photographing is being performed, conducts electronic zoom control that changes a cut-out range of a picked-up image based on an operation of the first operation section and the focusing operation section.

The above and other objects, features and advantages of the invention will become more clearly understood from the following description referring to the accompanying drawings.

### BRIEF DESCRIPTION OF THE DRAWINGS

FIG. 1 is a block diagram that illustrates a circuit configuration of an image pickup apparatus according to a first embodiment of the present invention;

FIG. 2 is an explanatory drawing that illustrates the external appearance of an image pickup apparatus 10 shown in FIG. 1 and interchangeable lenses that can be mounted to the image pickup apparatus 10;

FIG. 3A to FIG. 3C are block diagrams that illustrate circuit configurations of interchangeable lenses 20a′, 20b, and 20c shown in FIG. 2, respectively;

FIG. 4 is a flowchart that illustrates processing that controls a camera;

FIG. 5A and FIG. 5B are explanatory drawings that illustrate display examples on a main body display section 19;

FIG. 6 is an explanatory drawing that illustrates a second embodiment of the present invention;

FIG. 7 is a block diagram that illustrates a third embodiment of the present invention;

FIG. 8 is an explanatory drawing that illustrates an example of an eyepiece-type electronic viewfinder;

FIG. 9A and FIG. 9B are explanatory drawings that illustrate a state in which a user grasps an image pickup apparatus main body 2 horizontally and performs still image photographing in a state in which an electronic viewfinder 64 is attached to an accessory shoe 61;

FIG. 10A and FIG. 10B are explanatory drawings that illustrate a state when photographing a moving image;

FIG. 11 is a flowchart for explaining actions according to a third embodiment;

FIG. 12 is a flowchart that illustrates a fourth embodiment of the present invention; and

FIG. 13 is a chart for describing members that recognize a zoom operation.

### DETAILED DESCRIPTION OF THE PREFERRED EMBODIMENTS

Embodiments of the present invention are described hereunder with reference to the drawings.

### First Embodiment

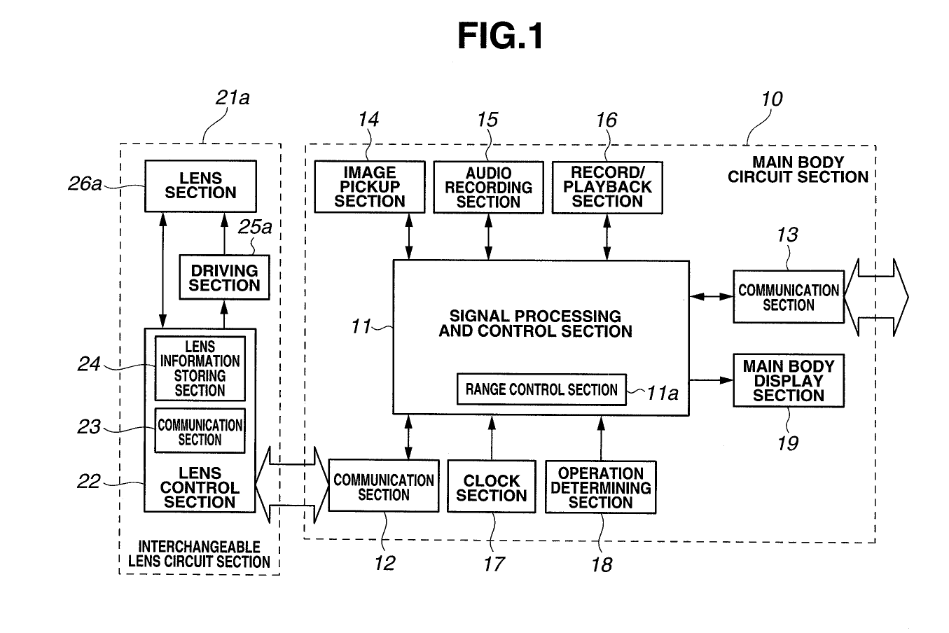

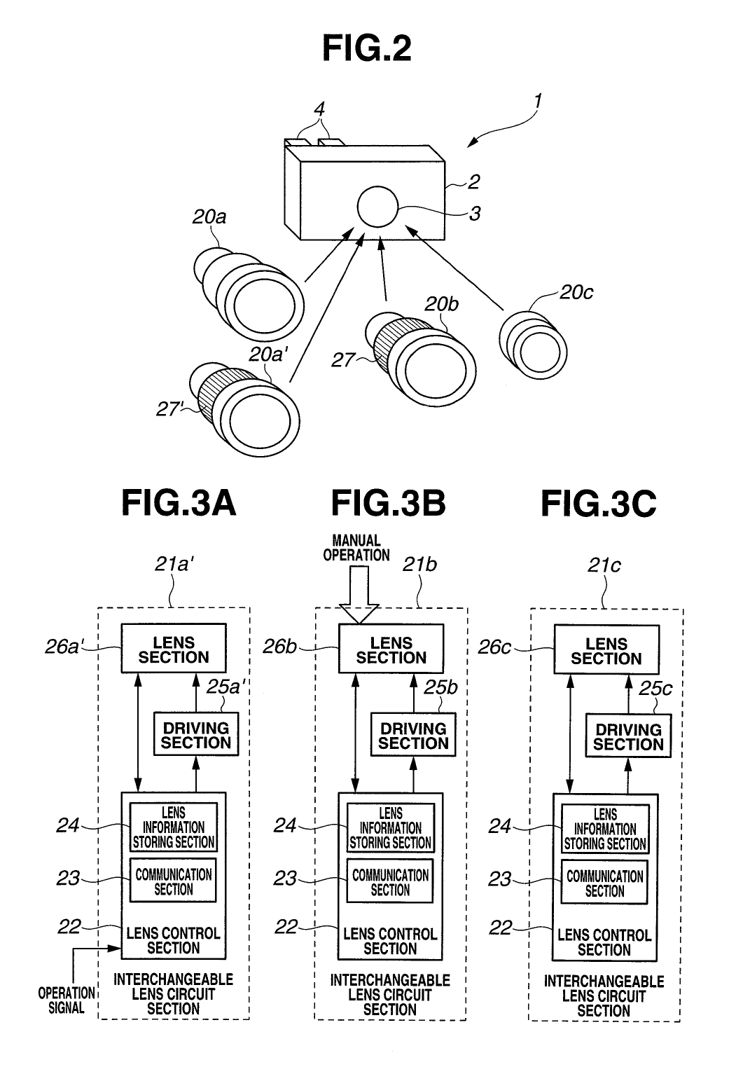

FIG. 1 is a block diagram that illustrates a circuit configuration of an image pickup apparatus according to a first embodiment of the present invention. FIG. 2 is an explanatory drawing that illustrates the external appearance of an image pickup apparatus 10 shown in FIG. 1 and interchangeable lenses that can be mounted to the image pickup apparatus 10. FIG. 3A to FIG. 3C are block diagrams that illustrate the circuit configurations of interchangeable lenses 20a′, 20b, and 20c shown in FIG. 2, respectively.

In FIG. 2, the image pickup apparatus 1 has a lens mount 3 on the front face of an image pickup apparatus main body 2. Interchangeable lenses 20a, 20a′, 20b, and 20c (hereunder, referred to representatively as “interchangeable lens 20”) and the like can be mounted to the lens mount 3. A zoom switch 4 is arranged at an upper portion of the back face of the image pickup apparatus main body 2.

### (Circuit Configuration)

A main body circuit section 10 is contained inside the image pickup apparatus main body 2 of the image pickup apparatus 1. As shown in FIG. 1, communication sections 12 and 13 are provided in the main body circuit section 10. Interchangeable lens circuit sections 21a, 21a′, 21b, and 21c (see FIG. 3A to FIG. 3C) (hereunder, referred to representatively as “interchangeable lens circuit section 21”) are contained inside the interchangeable lenses 20a, 20a′, 20b, and 20c according to the present embodiment. A communication section 23 is also provided in the interchangeable lens circuit section 21. The communication section 12 of the main body circuit section 10 is configured so that information can be sent to and received from the communication section 23 of the interchangeable lens circuit section 21.

The interchangeable lens 20a has a lens section 26a composed by a zoom lens. The lens section 26a is driven by a driving section 25a and has a zoom function. More specifically, the interchangeable lens 20a has a motorized zoom function. The lens section 26a is also equipped with an autofocus function that enables focusing when the lens section 26a is driven by the driving section 25a.

The interchangeable lens 20a′ is an interchangeable lens that performs a motorized zoom function by driving a motor based on a manual operation of a zoom ring (hereunder, also referred to as “motorized zoom function by a manual operation”). The interchangeable lens 20a′ is configured to electrically carry out a zoom function by driving a motor in accordance with an operation of a zoom ring 27′ provided on the interchangeable lens, and driving a lens section 26a′ by means of the rotational force of the motor. Note that, the lens section 26a′ is also equipped with an autofocus function that enables focusing when the lens section 26a′ is driven by a driving section 25a′.

According to the present embodiment, an interchangeable lens on which a zoom switch is installed can also be adopted as an interchangeable lens that obtains a motorized zoom function by a manual operation, and this kind of interchangeable lens is also described as the interchangeable lens 20a′.

The interchangeable lens 20b has a lens section 26b that is composed by a zoom lens. In the lens section 26b, zooming is performed by a manual operation of the zoom ring 27. That is, the interchangeable lens 20b has a manual zoom function. Note that, the lens section 26b is also equipped with an autofocus function that enables focusing when the lens section 26b is driven by a driving section 25b.

The interchangeable lens 20c has a lens section 26c of a fixed focal length. More specifically, the interchangeable lens 20c does not have a zoom function. Note that, the lens section 26c is equipped with an autofocus function that enables focusing when the lens section 26c is driven by a driving section 25c.

A lens control section 22 of the interchangeable lens circuit section 21 has a lens information storing section 24 that stores lens information and a communication section 23. The information stored as lens information includes information indicating whether a lens section is a zoom lens or a fixed focal length lens, whether a zoom function is manual, motorized, or motorized by a manual operation, and optical system information. The lens control sections 22 of the respective interchangeable lens circuit sections 21a, 21a′, 21b, and 21c have the same configuration, and include the lens information storing section 24 and the communication section 23.

The respective lens control sections 22 are controlled by the main body circuit section 10, and control the driving sections 25a, 25a′, 25b, and 25c (hereunder, referred to representatively as “driving section 25”) to drive the lens sections 26a, 26a′, 26b, and 26c (hereunder, referred to representatively as “lens section 26”) and thereby enable control of the diaphragm, focusing, zooming and the like at the lens section 26.

The communication section 23 of the lens control section 22 sends and receives information to and from the communication section 12 of the main body circuit section 10 via a predetermined transmission path. When communication is established with the communication section 12 of the main body circuit section 10, the lens control section 22 can send lens information that is read out from the lens information storing section 24 to the main body circuit section 10 by means of the communication section 23. Thus, the main body circuit section 10 can recognize what kind of zoom function the interchangeable lens 20 has, as well as the magnification, focal length, brightness number and the like of the zoom lens.

Note that, various kinds of interchangeable lenses can be employed according to the present embodiment. The interchangeable lenses that can be employed according to the present embodiment have a circuit configuration that has a lens control section including a lens information storing section and a communication section, and a driving section and the like similarly to the interchangeable lens circuit section 21, and are configured to send and receives information to and from the main body circuit section 10 and also to be controllable by the main body circuit section 10.

Note that, a communication section 13 is also provided in the main body circuit section 10. The communication section 13, for example, is configured to be capable of exchanging information with the electronic viewfinder and the like.

The main body circuit section 10 has an image pickup section 14 that is composed by an image pickup device such as a CCD or a CMOS sensor. An optical image of a subject from the interchangeable lens 20 is formed on an image pickup surface of the image pickup device that composes the image pickup section 14. The image pickup section 14 is drivingly controlled by a signal processing and control section 11. The signal processing and control section 11 has information regarding the image pickup surface of the image pickup device that composes the image pickup section 14. Based on the information regarding the image pickup surface and the lens information, the signal processing and control section 11 outputs a driving signal of the image pickup device to the image pickup section 14, and also captures an image signal that the image pickup device obtains by subjecting an optical image to photoelectric conversion. An audio recording section 15 is also provided in the main body circuit section 10. The audio recording section 15 is configured to record sounds outside the image pickup apparatus 1 and output audio signals to the signal processing and control section 11.

The signal processing and control section 11 performs predetermined signal processing, for example, color signal generating processing and matrix conversion processing and various other kinds of digital processing with respect to image signals obtained by means of the photoelectric conversion that is performed by the image pickup device. The main body circuit section 10 is configured to be also capable of outputting image information and audio information and the like that has been subjected to an encoding process and compressed when recording image signals and audio signals and the like.

A clock section 17 and an operation determining section 18 are also arranged in the main body circuit section 10. The clock section 17 generates time information that the signal processing and control section 11 uses. The operation determining section 18 is configured to generate operation signals based on user operations with respect to various switches such as an unshown release switch and a photographing mode setting switch that are provided on the image pickup apparatus 1, and output the operation signals to the signal processing and control section 11. The signal processing and control section 11 controls each section based on the operation signals.

For example, the operation determining section 18 can generate an operation signal based on a zoom operation of the zoom switch 4 that is provided on the image pickup apparatus main body 2, and the signal processing and control section 11 can perform zoom processing based on the zoom operation of the zoom switch 4.

Note that, a configuration may also be adopted in which a touch panel is provided on a main body display section 19 that is described later, and the zoom switch 4 of the camera body is provided as an icon on the touch panel, and not as a mechanical switch.

According to the present embodiment, the signal processing and control section 11 is configured so as to switch the type of zoom processing based on lens information from the interchangeable lens 20. More specifically, when the interchangeable lens 20a that has a motorized zoom function is mounted as the interchangeable lens 20, the signal processing and control section 11 drives the lens section 26a of the interchangeable lens 20a to cause the interchangeable lens 20a to execute a zoom action based on a zoom operation of the zoom switch 4. That is, the signal processing and control section 11 generates a zoom signal based on an operation signal from the operation determining section 18, and sends the zoom signal to the lens control section 22 of the interchangeable lens circuit section 21a via the communication section 12. The lens control section 22 controls the driving section 25a to perform a zoom action by driving an unshown zoom mechanism section of the lens section 26a in accordance with the zoom signal.

The interchangeable lens 21a′ that realizes a motorized zoom function by driving a motor in accordance with an operation of a zoom ring may also be mounted as an interchangeable lens. With respect to the interchangeable lens 21a′ also, an operation signal that is based on an operation of the zoom ring 27′ is supplied to the signal processing and control section 11 via the communication section 12 from the communication section 23 of the interchangeable lens circuit section 21a′.

Accordingly, when the interchangeable lens 20a′ is mounted, an operation signal based on a zoom operation of the zoom switch 4 provided on the image pickup apparatus main body 2 and an operation signal based on an operation of the zoom ring 27′ of the interchangeable lens 20a′ are inputted to the signal processing and control section 11.

The signal processing and control section 11 selectively uses one of the aforementioned operation signals or uses both of the operation signals to perform zoom processing. The signal processing and control section 11 generates a zoom signal in accordance with an operation signal that is based on an operation of at least one of the zoom switch 4 and the zoom ring 27′, and sends the zoom signal to the lens control section 22 of the interchangeable lens circuit section 21a′ via the communication section 12. The lens control section 22 controls the driving section 25a′ to carry out a zoom action by driving the zoom mechanism section of the lens section 26a′ in accordance with the zoom signal.

The interchangeable lens 20b that has a manual zoom function may also be mounted as the interchangeable lens. In this case, a zooming process is performed by a manual operation with respect to the zoom ring 27. In this case also, it can be considered that the user may operate the zoom switch 4 provided on the image pickup apparatus main body 2. When a zoom operation of the zoom switch 4 is performed, the signal processing and control section 11 carries out so-called electronic zoom processing which is zoom processing that extracts and outputs an image region of one portion in an image pickup range of the image pickup section 14.

A range control section 11a of the signal processing and control section 11 determines for which image region in the image pickup range an image is to be extracted based on the zoom operation performed by the zoom switch 4. Accordingly, in this case, zoom processing is performed with respect to both optical zooming by the zoom ring 27 and electronic zooming by the zoom switch 4.

The interchangeable lens 20c that has a fixed focal length lens may also be mounted as an interchangeable lens. In this case, based on a zoom operation of the zoom switch 4, the signal processing and control section 11 performs electronic zoom processing that extracts and outputs an image region of one portion of the image pickup range of the image pickup section 14.

Further, when the interchangeable lens 20a′ is mounted as the interchangeable lens, a case can be considered in which the interchangeable lens 20a′ employed as the interchangeable lens is a lens that detects that a zoom operation by the zoom ring 2′T has reached a limit point by means of a zoom ring operation and generates an operation limit signal. When the operation limit signal is inputted to the signal processing and control section 11 via the communication section 12, the signal processing and control section 11 can also switch the zoom processing from optical zooming to electronic zooming. More specifically, electronic zoom processing is performed during a period in which a zoom operation by the zoom ring 27′ is maintained at a limit point.

Note that, by providing a sensor that generates this kind of operation limit signal inside the interchangeable lens 20b that has the manual zoom function, it is possible to switch from optical zooming to electronic zooming with respect to the interchangeable lens 20b also by operating only the zoom ring.

A record/playback section 16 and a main body display section 19 are also provided in the main body circuit section 10. The record/playback section 16 is configured to be capable of recording image information and audio information from the signal processing and control section 11 on an unshown recording medium. For example, a card interface can be employed as the record/playback section 16, and the record/playback section 16 can record image information and audio information and the like on a memory card or the like. The record/playback section 16 can also read out image information and audio information that is recorded on a recording medium and supply the image information and audio information to the signal processing and control section 11. The signal processing and control section 11 is configured to be capable of decoding the image information and audio information from the record/playback section 16 to obtain image signals and audio signals.

A picked-up image from the image pickup section 14 or a playback image from the record/playback section 16 is supplied from the signal processing and control section 11 to the main body display section 19. The main body display section 19 can display the picked-up image or playback image that is supplied. The main body display section 19 is configured to be controlled by the signal processing and control section 11 so as to be capable of also displaying a menu display and the like for carrying out operations of the image pickup apparatus 1. For example, the main body display section 19 is configured to be controlled by the signal processing and control section 11 so as to be capable of also displaying a display relating to zoom processing.

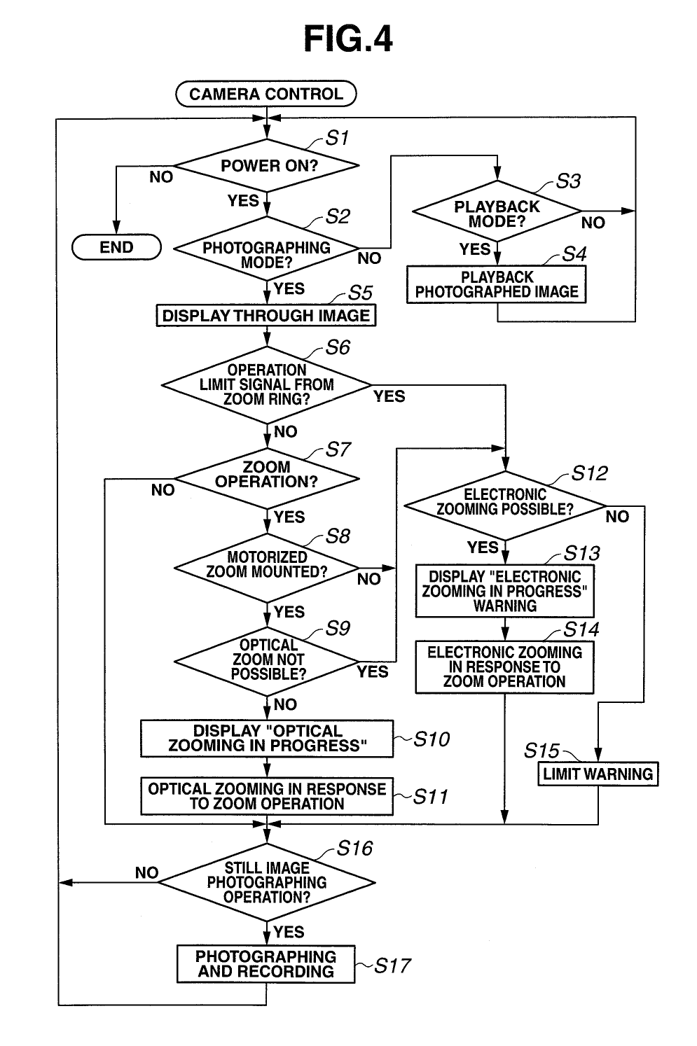

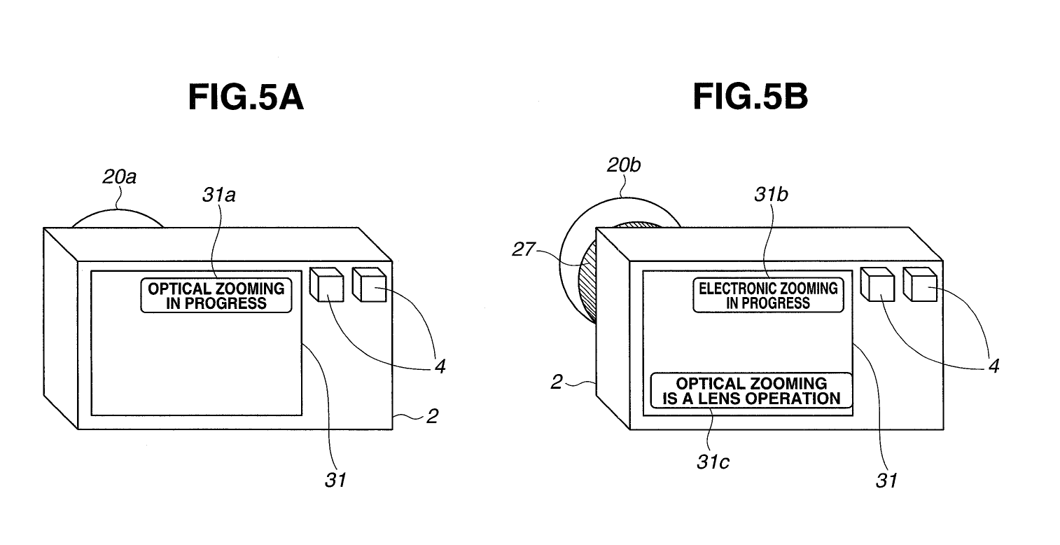

Next, the actions of the embodiment configured in this manner are described referring to FIG. 4, FIG. 5A, and FIG. 5B. FIG. 4 is a flowchart that illustrates processing that controls a camera. FIG. 5A and FIG. 5B are explanatory drawings that illustrate display examples with respect to the main body display section 19.

When the power of the image pickup apparatus 1 is turned on, the processing shown in FIG. 4 shifts from step S1 to step S2, and the signal processing and control section 11 determines whether or not an instruction to perform operations in a photographing mode has been inputted. If an instruction to perform operations in the photographing mode has not been inputted, in step S3, the signal processing and control section 11 determines whether or not an instruction to perform operations in a playback mode has been inputted. If an instruction to perform operations in the playback mode has been inputted, in step S4, the signal processing and control section 11 plays back a photographed image.

In contrast, if an instruction to perform operations in the photographing mode has been inputted, in step S5, the signal processing and control section 11 displays a picked-up image (through image) on the main body display section 19 based on an image signal from the image pickup section 14.

Steps S6 to S15 relate to zoom processing. When a zoom operation is not performed, the processing shifts to step S16 via steps S6 and S7, and the signal processing and control section 11 determines whether or not a still image photographing operation has been performed. If a still image photographing operation has been performed, in step S17, the signal processing and control section 11 performs photographing and recording.

More specifically, after performing predetermined signal processing on an image signal from the image pickup section 14, the signal processing and control section 11 performs an encoding process and transfers image information from the record/playback section 16 to a recording medium. Thus, the image information transferred from the record/playback section 16 is filed.

In step S6, the signal processing and control section 11 determines whether or not an operation limit signal is generated based on a zoom operation of the zoom ring 27 or 27′. Note that if an interchangeable lens that does not output an operation limit signal is mounted, this step is omitted. If an operation limit signal is not generated, in the subsequent step S7, the signal processing and control section 11 determines whether or not a zoom operation has been performed. If a zoom operation has been performed, the signal processing and control section 11 determines whether or not the mounted interchangeable lens has a motorized zoom function (step S8).

If the mounted interchangeable lens has a motorized zoom function, next, in step S9, the signal processing and control section 11 determines whether or not an optical zoom operation is not possible. Depending on the operation mode, there are cases in which the signal processing and control section 11 does not perform optical zoom processing even if optical zoom processing is available. For example, when photographing a moving image, in some cases smooth movement of a zoom position and silencing control that does not generate a mechanical sound are necessary, and motorized zoom processing that is realized by rotation of a motor does not satisfy these requirements. Further, a moving picture that is picked up by an image pickup apparatus is generally viewed using a television receiver or the like. Since the resolution of a digital camera is sufficiently high compared to the resolution of a general television receiver, even if electronic zooming is employed that causes a decrease in resolution when photographing a moving image, the deterioration in image quality is rarely a cause of annoyance when the captured moving image is being viewed. Therefore, when performing such kind of moving image photographing, or when it is determined that the limit of the optical zooming has been reached, the signal processing and control section 11 determines in step S9 that optical zoom processing is not possible.

If the signal processing and control section 11 does not determine that optical zooming is not possible, the processing advances to step S10. In step S10, the signal processing and control section 11 controls the main body display section 19 to display a message “optical zooming in progress”.

FIG. 5A shows a display example in this case. As shown in FIG. 5A, a display section 31 that constitutes the main body display section 19 is provided on the rear surface of the image pickup apparatus main body 2. A through image (omitted from the drawing) is being displayed on the display section 31. The main body display section 19 displays a display 31a with the words “optical zooming in progress” on the screen while the through image is being displayed.

By means of this display, the user can confirm that optical zooming is performed as the result of an operation of the zoom switch 4 or an operation of the zoom ring 27′ or the like performed by the user.

Next, in step S11, the signal processing and control section 11 sends a zoom signal that corresponds to the zoom operation to the interchangeable lens 20a or 20a′ or the like via the communication section 12. As a result, optical zooming is performed. Note that, a through image according to the zoom processing is displayed on the main body display section 19.

Here, in a case in which an interchangeable lens that does not have a motorized zoom function is mounted as the interchangeable lens, or in the case of an operation mode in which optical zooming is not possible even though the interchangeable lens has a motorized zoom function, or in a case in which an operation limit signal for optical zooming is being generated, the processing shifts to step S12. In step S12, the signal processing and control section 11 determines whether or not electronic zooming is possible. If electronic zooming is already being performed to the limit, the processing shifts to step S15. In step S15, the signal processing and control section 11 displays a warning on the display section 31 of the main body display section 16.

If electronic zooming is possible, the signal processing and control section 11 controls the main body display section 19 to display a message “electronic zooming in progress” in step S13.

FIG. 5B shows a display example in this case. As shown in FIG. 5B, a display 31b with the message “electronic zooming in progress” is being displayed on the screen while a through image (omitted from the drawing) is being displayed on the display section 31. By means of this display, the user can confirm that electronic zooming is performed as the result of an operation of the zoom switch 4 or the zoom ring 27′ or the like performed by the user.

Next, in step S14, in response to the zoom operation, the signal processing and control section 11 extracts only an image of a range that is based on the zoom operation from the picked-up image from the image pickup section 14, and outputs the extracted image to the main body display section 19. Thus, electronic zooming is performed.

The processing of steps S12 to S15 is performed not only when the interchangeable lens 20a or 20c that has a motorized zoom function is mounted, but also when the interchangeable lens 20b or 20c that does not have a motorized zoom function is mounted. Thus, according to the present embodiment, even when the interchangeable lens 20b or 20c or the like that does not have a motorized zoom function is mounted, electronic zooming can be performed by an operation of the zoom switch 4.

However, when electronic zooming is performed, since an image of one portion of the image pickup range is extracted, the number of pixels of the picked-up image decreases. Therefore, when performing electronic zooming in a case where the interchangeable lens 20b that has a manual zoom function is mounted, as shown in FIG. 5B, the signal processing and control section 11 displays a display 31c with a message “optical zooming is a lens operation” that notifies the user that optical zooming is performed by operating the zoom ring.

Note that, a configuration may also be adopted in which an operation limit signal is generated that indicates that the limit of optical zooming has been reached by an operation of the zoom switch 4 also, and which shifts from optical zooming to electronic zooming in accordance with an operation of the zoom switch 4.

Thus, according to the present embodiment, an image pickup apparatus that has a zoom switch on the image pickup apparatus main body determines the type of interchangeable lens that is mounted and switches the zoom processing accordingly, and even when an interchangeable lens that does not have a motorized zoom function is mounted, a zoom function can be achieved by performing electronic zooming by means of a zoom operation by the zoom switch.

For example, when the image pickup apparatus includes a zoom switch, a case can be considered in which a user operates the zoom switch even when an interchangeable lens that has a zoom ring is mounted. In this case also, according to the present embodiment, it is possible to perform electronic zooming by operating the zoom switch, and thus an image pickup apparatus with excellent operability can be provided.

Further, according to the present embodiment, since a display is provided that shows whether motorized zoom processing is performed or electronic zoom processing is performed according to an operation of the zoom switch, the image pickup apparatus provides excellent convenience to the user.

### Second Embodiment

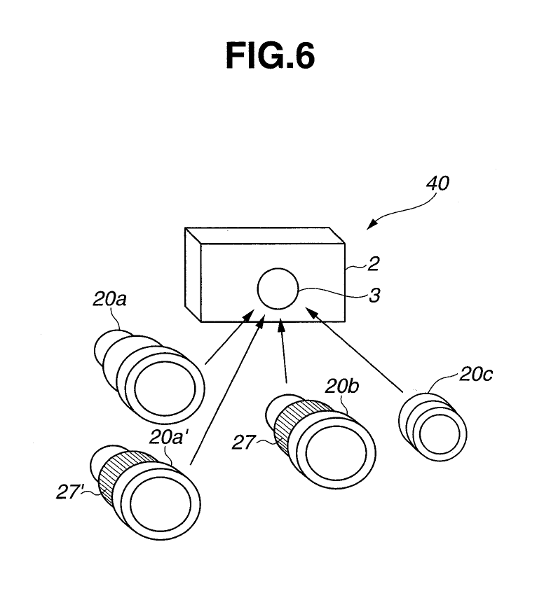

FIG. 6 is an explanatory drawing that illustrates a second embodiment of the present invention. Components in FIG. 6 that are the same as in FIG. 2 are denoted by the same reference numerals, and a description of such components is omitted hereunder.

An image pickup apparatus 40 according to the present embodiment differs from the image pickup apparatus 1 according to the first embodiment only in the respect that the image pickup apparatus 40 does not have a zoom switch. The circuit configuration of the present embodiment is the same as in FIG. 1.

Similarly to the first embodiment, various interchangeable lenses such as the interchangeable lenses 20a, 20a′, 20b, and 20c can also be mounted according to the embodiment configured in this manner. In the present embodiment, if the interchangeable lens 20a or 20c that is not provided with a zoom ring or a zoom switch or the like for controlling a zoom function is mounted, the signal processing and control section 11 controls zoom processing by utilizing various operation members provided on the image pickup apparatus main body 2 as an operation section for zoom operations. Further, a configuration may also be adopted in which a touch panel is provided on the main body display section 19 and zoom control is performed in accordance with the location of a touch operation on the touch panel.

For example, when the image pickup apparatus 40 is in the photographing mode, if an operation signal based on a user operation with respect to a menu key or a touch panel or the like is inputted from the operation determining section 18, the signal processing and control section 11 performs zoom processing in accordance with the operation signal. For example, when the interchangeable lens 20a is mounted, the signal processing and control section 11 operates in the same manner as in the first embodiment to perform optical zoom processing or electronic zoom processing in accordance with an operation of a menu key or a touch panel or the like of the image pickup apparatus main body.

Further, when the interchangeable lens 20b or 20c is mounted, the signal processing and control section 11 operates in the same manner as in the first embodiment to perform electronic zoom processing in accordance with an operation of a menu key or a touch panel or the like of the image pickup apparatus main body.

Note that, when the interchangeable lens 20a′ that includes a zoom ring or a zoom switch or the like for controlling the zoom function is mounted, the signal processing and control section 11 operates in a similar manner to the first embodiment to perform optical zoom processing or electronic zoom processing in accordance with an operation of the zoom ring or the like.

According to the present embodiment configured in this manner, even if a zoom switch is not provided on the image pickup apparatus main body, optical zooming or electronic zooming is possible in accordance with the type of interchangeable lens.

### Third Embodiment

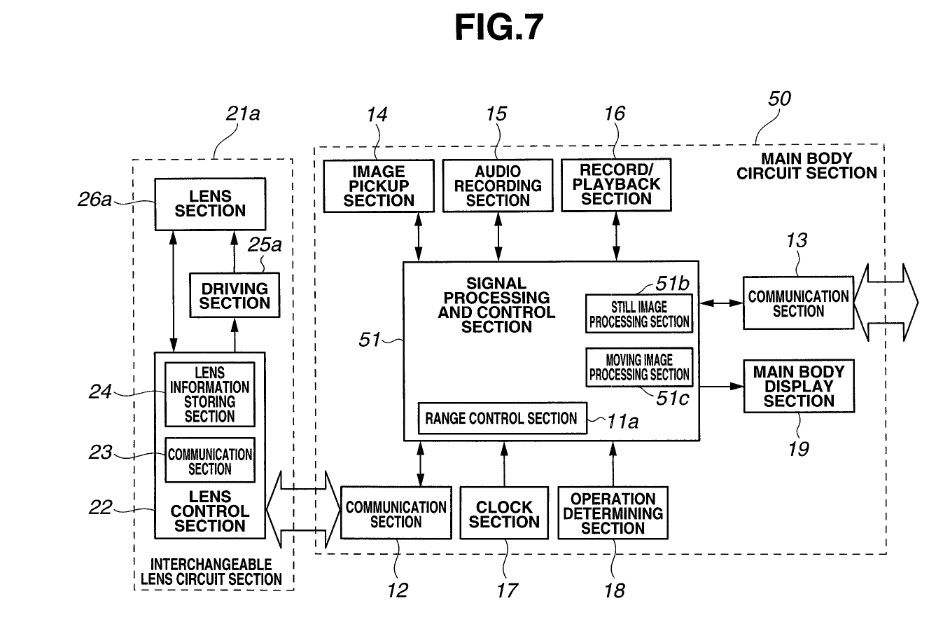

FIG. 7 is a block diagram that illustrates a third embodiment of the present invention. Components in FIG. 7 that are the same as in FIG. 1 are denoted by the same reference numerals, and a description of such components is omitted hereunder.

The present embodiment differs from the first embodiment only in the respect that the present embodiment employs a main body circuit section 50 that has a signal processing and control section 51 that includes a still image processing section 51b and a moving image processing section 51c.

The still image processing section 51b subjects a picked-up image from the image pickup section 14 to image compression processing as a still image. The moving image processing section 51c subjects picked-up images from the image pickup section 14 to interframe compression and processes the images as a moving picture.

The signal processing and control section 51 according to the present embodiment has the same configuration as the signal processing and control section 11 shown in FIG. 1, and provides the same actions as the signal processing and control section 11 excluding the point that the signal processing and control section 51 performs different zoom processing when photographing a still image and when photographing a moving image.

Note that, when photographing a still image it is better to use an eyepiece-type electronic viewfinder to enable reliable framing of a subject. Use of such an eyepiece-type electronic viewfinder facilitates confirmation of color reproducibility and exposure correction.

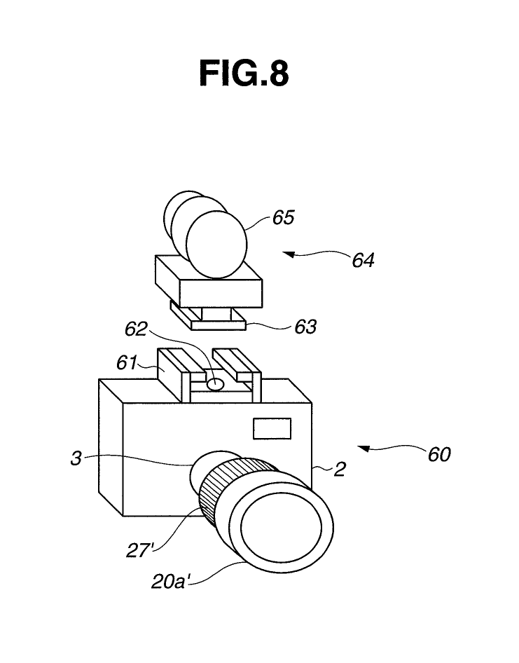

FIG. 8 is an explanatory drawing that illustrates an example of this kind of eyepiece-type electronic viewfinder.

The interchangeable lens 20a′ is mounted to the lens mount 3 on the front face of the image pickup apparatus main body 2. An accessory shoe 61 is provided on the upper end of the image pickup apparatus main body 2. The electronic viewfinder 64 has an attaching portion 63 for detachably attaching the electronic viewfinder 64 to the accessory shoe 61.

A contact section 62 that constitutes the communication section 13 of the main body circuit section 10 is provided on the accessory shoe 61. By attaching the attaching portion 63 of the electronic viewfinder 64 to the accessory shoe 61, the contact section 62 is electrically connected to an unshown contact section provided on the attaching portion 63. A display section 65 to which video signals and the like are supplied via the communication section 13 of the main body circuit section 10 and which displays the video signals is provided on the electronic viewfinder 64.

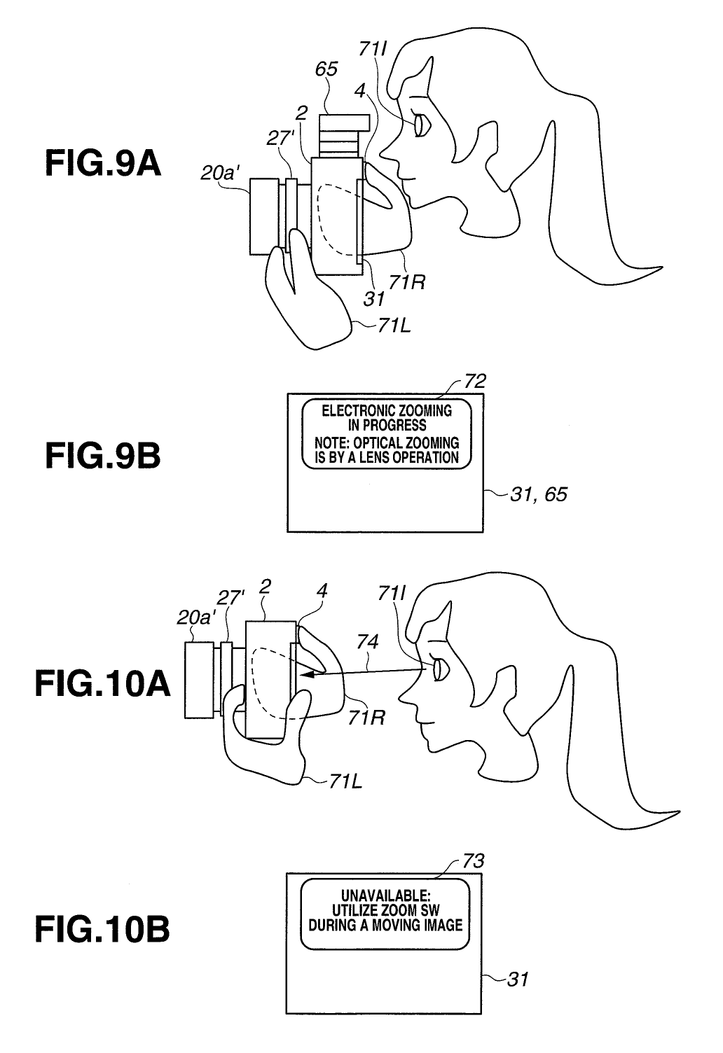

FIG. 9A and FIG. 9B are explanatory drawings that illustrate a state in which a user grasps the image pickup apparatus main body 2 horizontally and performs still image photographing in a state in which the electronic viewfinder 64 is attached to the accessory shoe 61. FIG. 9A illustrates an example of horizontal composition photography in which the image pickup apparatus main body 2 is set in a horizontal posture. When performing this kind of still image photographing, accurate framing is possible by performing photographing while viewing the display of the display section 65 of the electronic viewfinder 64.

The method illustrated in FIG. 9A is the common way of setting an image pickup apparatus when performing still image photographing. That is, the user places the image pickup apparatus main body 2 on a left hand 71L in a state in which the interchangeable lens 20a′ is lightly held between the thumb and the other fingers of the left hand 71L, and holds a side portion of the image pickup apparatus main body 2 with the thumb and the other fingers of a right hand 71R. In this state, the user brings an eye 711 close to the display section 65 of the electronic viewfinder 64. This posture allows the user to securely hold the image pickup apparatus main body 2 and enables stable photographing.

FIG. 10A and FIG. 10B are explanatory drawings that illustrate a state when performing moving image photographing. When performing moving image photographing, as shown in FIG. 10A, a manner that allows the user to check a through image displayed on the finder 65 with the eye 711 as indicated by a line of sight 74 and at the same time look straight at a subject is advantageous for photographing. Thus, even an image in which there is movement can be reliably photographed. More specifically, when photographing in this case the user observes the display section 31 of the main body display section 19 that is provided on the rear surface of the image pickup apparatus main body 2.

Accordingly, when photographing a moving image, in order to set the image pickup apparatus main body 2 at a position that is a small distance away from the user's body, the user grasps the image pickup apparatus main body 2 while sandwiching a side portion of a bottom side of the image pickup apparatus main body 2 between the thumb and the other fingers of the left hand 71L, and holds the side portion of the image pickup apparatus main body 2 between the thumb and the other fingers of the right hand 71R.

According to the manner of setting the image pickup apparatus main body 2 shown in FIG. 9A, it is natural for the user to perform a zoom operation using the zoom ring 27′. Conversely, according to the manner of setting the image pickup apparatus main body 2 shown in FIG. 10A, it is natural for the user to perform a zoom operation using the zoom switch 4 provided on the rear surface of the image pickup apparatus main body 2. In particular, when photographing a moving image, using the zoom switch 4 to perform a zoom operation offers superior stability compared to using the zoom ring 27′ to perform a zoom operation.

The signal processing and control section 51 is configured to switch the zoom processing in accordance with these differences in the photographing form when photographing a still image and photographing a moving image.

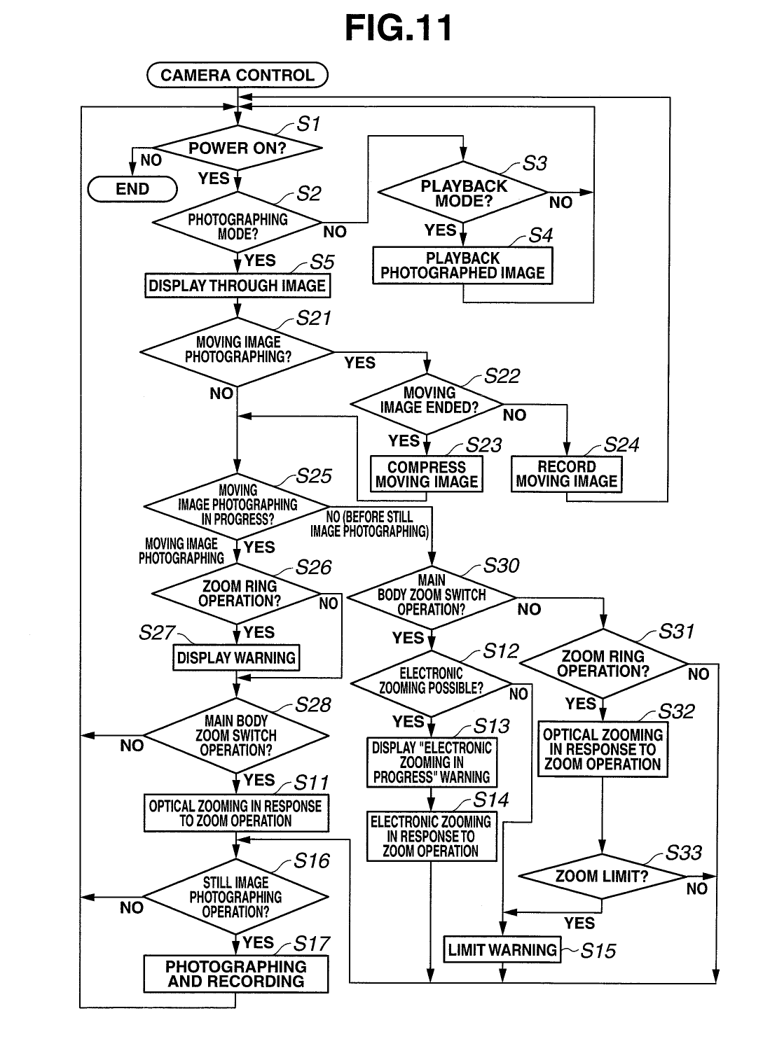

Next, actions of the embodiment configured in this manner are described referring to the flowchart shown in FIG. 11. Steps in FIG. 11 that are the same as in FIG. 4 are denoted by the same reference numerals, and a description of those steps is omitted hereunder. FIG. 11 shows actions when the interchangeable lens 20a′ is mounted as an interchangeable lens.

When the image pickup apparatus of the present embodiment is in the photographing mode, a through image is displayed in step S5. The through image is displayed on the display section 65 of the electronic viewfinder 64 or the display section 31 of the main body display section 2. Next, in step S21, the signal processing and control section 51 determines whether or not moving image photographing is being performed. When moving image photographing is being performed, in step S22, the signal processing and control section 51 determines whether or not the moving image photographing has ended. If the moving image photographing has not ended, the signal processing and control section 51 performs moving image compression at the moving image processing section 51c. If the moving image photographing has ended, in step S24, the moving image processing section 51c carries out recording of the moving image that has been compressed.

In step S25, the signal processing and control section 51 determines whether the state is a state in which moving image photographing is in progress or is a state before photographing a still image. If moving image photographing is in progress, the signal processing and control section 51 determines whether or not a zoom ring operation has been performed (step S26).

According to the present embodiment, during moving image photographing, zoom processing is controlled by the zoom switch 4 that is provided on the image pickup apparatus main body 2. Accordingly, if the zoom ring 27′ is operated, the signal processing and control section 51 displays a warning in step S27 and disregards the zoom ring operation.

FIG. 10B illustrates an example of a warning that is displayed in this case. The signal processing and control section 51 displays a display 73 with the message “Unavailable: utilize zoom SW during a moving image” that informs the user that operation of the zoom ring 27′ is unavailable and urges the user to operate the zoom switch on the display section 31.

Next, in step S28, if the signal processing and control section 51 detects that the zoom switch 4 has been operated, the signal processing and control section 51 generates a zoom signal based on the operation signal to conduct optical zooming based on the zoom operation of the zoom switch 4 (step S11).

In contrast, when moving image photographing is not in progress, the signal processing and control section 51 shifts the processing from step S25 to step S30. In step S30, the signal processing section and control section 51 determines whether or not an operation of the zoom switch 4 has been performed, and in step S31 determines whether or not an operation of the zoom ring 27′ has been performed.

More specifically, when performing still image photographing, optical zooming based on an operation of the zoom ring 27′ and electronic zooming based on an operation of the zoom switch 4 are both possible. If the zoom switch 4 has been operated, in steps S12 to S14 the signal processing and control section 51 performs electronic zooming based on the zoom switch 4 operation.

Further, in this case, as shown in FIG. 9B, the signal processing and control section 51 displays a message “Electronic zooming in progress” that indicates that electronic zooming is being performed by an operation of the zoom switch 4 and a display 72 with a message “Note: optical zooming is by a lens operation” that indicates that optical zooming is performed by operation of the zoom ring 27′, on the display section 31 and the display section 65.

In contrast, when the zoom ring 27′ has been operated, in step S32, optical zooming is performed based on the zoom ring 27′ operation. Note that, if the zoom limit of optical zooming is reached, the processing shifts from step S33 to step S15 to display a zoom limit warning.

Thus, according to the present embodiment, by switching the zoom processing in accordance with photographing of a moving image and photographing of a still image and inhibiting zoom processing by means of the zoom ring when photographing a moving image, it is possible to prevent a loss in the photographing stability due to a zoom operation.

### Fourth Embodiment

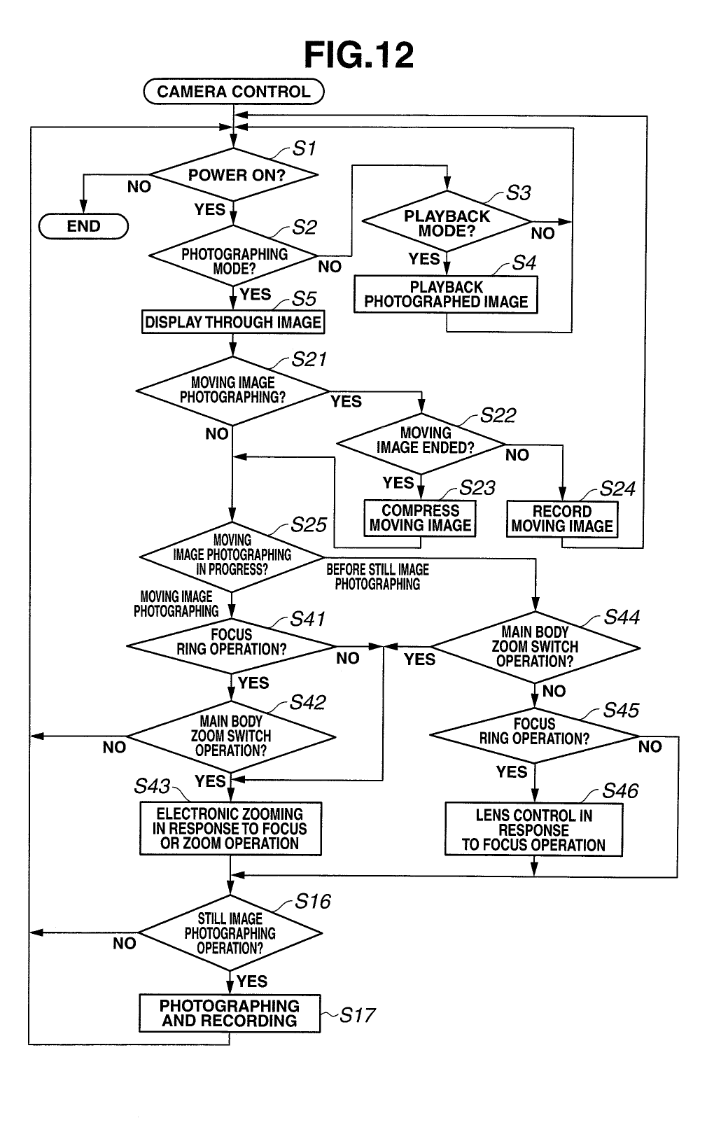

FIG. 12 is a flowchart that illustrates a fourth embodiment of the present invention. Steps in FIG. 12 that are the same as in FIG. 11 are denoted by the same reference numerals, and a description of such steps is omitted hereunder.

The circuit configuration of the present embodiment is the same as that of the third embodiment. The only difference between the present embodiment and the second embodiment are the actions in a case where the interchangeable lens 20c that has a fixed focal length lens is mounted.

When photographing a moving image, recording of picked-up images is performed even in a state in which a focusing operation is in progress, more specifically, in a non-focused state. According to the present embodiment, when photographing a moving image a focusing action in response to a manual focusing operation is inhibited, and only autofocus is enabled. Thus, recording of picked-up images in a non-focused state is prevented. The present embodiment also enables zoom processing to be performed in response to a focus ring operation when photographing a moving image.

When the signal processing and control section 51 determines in step S25 that moving image photographing is in progress, in the subsequent step S41, the signal processing and control section 51 determines whether or not the focus ring has been operated, and in step S42, determines whether or not the zoom switch 4 of the image pickup apparatus main body 2 has been operated. If either of these operations is performed, the signal processing and control section 51 performs electronic zooming based on the relevant operation during the moving image photographing (step S43).

In contrast, if moving image photographing is not in progress, the signal processing and control section 51 shifts the processing from step S25 to step S44. In step S44, the signal processing section and control section 51 determines whether or not an operation of the zoom switch 4 has been performed, and in step S45 determines whether or not a focus ring operation has been performed. If an operation of the zoom switch 4 has been performed, the signal processing and control section 51 shifts the processing to step S43 and performs electronic zooming. If the signal processing and control section 51 determines that a focus ring operation has been performed, in step S46, the signal processing and control section 51 performs a focusing action in response to the focusing operation.

More specifically, when photographing a still image, electronic zooming that is based on an operation of the zoom switch 4 is possible, and a focusing action is also performed based on an operation of the focus ring. In contrast, when photographing a moving image, electronic zooming is performed in both the case of an operation of the zoom switch 4 and a focus ring operation. Note that autofocus is performed when photographing a moving image also (not shown in the drawing).

Thus, the present embodiment is configured so that electronic zooming is performed and a manual focusing operation is not performed during moving image photographing. Hence, recording of a picked-up image in a non-focused state can be prevented. Further, it is possible to perform electronic zooming by a focusing operation, and thus the present embodiment provides excellent convenience to the user.

In addition, although a case is described above in which the zoom switch 4 is provided on the image pickup apparatus main body 2, the present embodiment can also be applied to an image pickup apparatus 40 (see FIG. 6) that does not have the zoom switch 4. In this case, the processing of steps S42 and S44 can be omitted. Further, in this case, even if a zoom switch is not provided on the image pickup apparatus main body 2, there is the advantage that a zoom operation can be controlled by the focus ring.

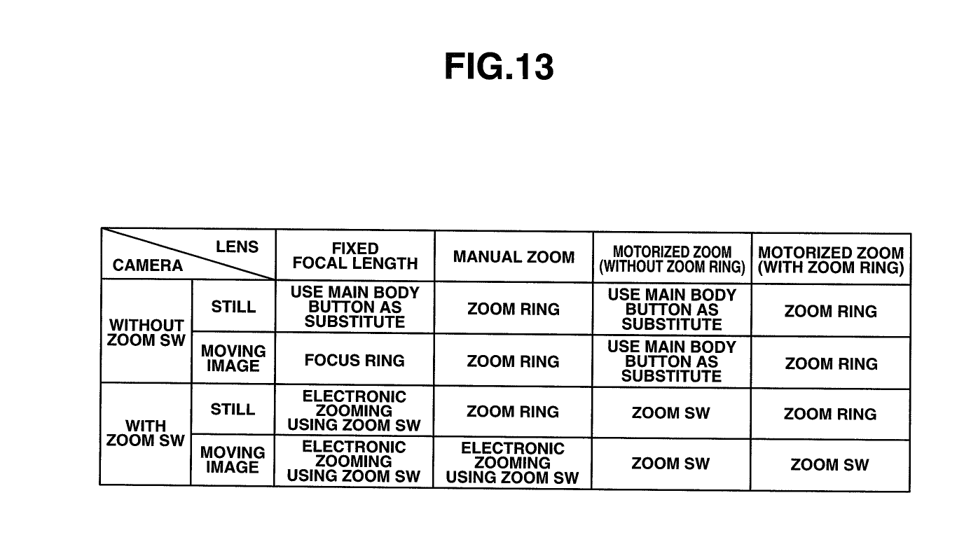

The present invention is not limited to the foregoing embodiments and various changes and modifications are possible, and appropriate zoom processing can be selected in accordance with the type of interchangeable lens, the presence or absence of a zoom switch, and the photographing mode and the like. FIG. 13 is an explanatory view that illustrates an example of such kind of zoom processing selection that includes the processing of the above described embodiments.

In FIG. 13, with respect to the interchangeable lens 20c that has a fixed focal length lens, the interchangeable lens 20b that has a manual zoom function, the interchangeable lens 20a that has a motorized zoom function, and the interchangeable lens 20a′ that has a motorized zoom function based on a manual operation, members are shown that recognize a zoom operation when photographing a still image (still) and when photographing a moving image (moving image) in correspondence with the presence or absence of a zoom switch (zoom SW).

Note that FIG. 13 illustrates one example, and control that is different from that in FIG. 13 is also possible.

Having described the preferred embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. An image pickup apparatus to which a first lens capable of motorized zooming and a second lens that is not capable of motorized zooming can be detachably mounted, comprising:
a first operation section for controlling zoom processing; and
a control section that, when the first lens is mounted, conducts optical zoom processing that controls a zoom lens of the first lens based on an operation of the first operation section, and when the second lens is mounted, conducts electronic zoom control that changes a cut-out range of a picked-up image based on an operation of the first operation section.

2. The image pickup apparatus according to claim 1, wherein:
the first lens comprises a second operation section for controlling the zoom lens; and
when the first lens is mounted, the control section conducts optical zoom processing that controls the zoom lens of the first lens based on an operation of at least one of the first and second operation sections.

3. The image pickup apparatus according to claim 1, wherein:
the first lens comprises a second operation section for controlling the zoom lens; and
when the first lens is mounted, the control section conducts optical zoom processing that controls the zoom lens of the first lens based on an operation of the second operation section, and conducts electronic zoom control that changes a cut-out range of a picked-up image based on an operation of the first operation section.

4. The image pickup apparatus according to claim 3, wherein:
the second operation section is configured to be capable of outputting an operation limit signal that indicates that a zoom control by the zoom lens has reached a limit; and
when the operation limit signal is received, the control section conducts electronic zoom control that changes a cut-out range of the picked-up image.

5. The image pickup apparatus according to claim 1, wherein the second lens has a manual zoom function for manually controlling a zoom lens.

6. The image pickup apparatus according to claim 5, wherein:
the second lens comprises a third operation section for manually controlling the zoom lens, that is configured to be capable of outputting an operation limit signal that indicates that a zoom control by the zoom lens has reached a limit; and
when the operation limit signal is received, the control section conducts electronic zoom control that changes a cut-out range of the picked-up image.

7. The image pickup apparatus according to claim 5, wherein when an operation is performed by the first operation section, the control section displays a display for notifying that optical zooming by a manual operation is possible.

8. The image pickup apparatus according to claim 1, wherein the second lens is a fixed focal length lens.

9. The image pickup apparatus according to claim 1, wherein the control section displays a display that shows whether either of the optical zoom processing and the electronic zoom processing is in progress.

10. The image pickup apparatus according to claim 3, wherein the control section displays a display that shows whether either of the optical zoom processing and the electronic zoom processing is in progress.

11. The image pickup apparatus according to claim 4, wherein the control section displays a display that shows whether either of the optical zoom processing and the electronic zoom processing is in progress.

12. The image pickup apparatus according to claim 1, wherein, during moving image photographing, even when the first lens is mounted, the control section conducts electronic zoom control that changes a cut-out range of a picked-up image based on an operation of the first operation section.

13. The image pickup apparatus according to claim 4, wherein, when the operation limit signal is received, even in a case where the first lens is mounted, the control section conducts electronic zoom control that changes a cut-out range of a picked-up image based on an operation of the first operation section.

14. An image pickup apparatus to which a first lens that has a second operation section for controlling a zoom lens and that is capable of motorized zooming can be detachably mounted, comprising:
a first operation section for controlling zoom processing; and
a control section that, when moving image photographing is not being performed, conducts optical zoom processing that controls the zoom lens based on an operation of the second operation section and conducts electronic zoom control that changes a cut-out range of a picked-up image based on an operation of the first operation section, and when moving image photographing is being performed, disregards an operation of the second operation section and conducts optical zoom processing that controls the zoom lens based on an operation of the first operation section.

15. The image pickup apparatus according to claim 14, wherein when the second operation section is operated during photographing of a moving image, the control section displays a warning that indicates that an operation of the second operation section is unavailable.

16. The image pickup apparatus according to claim 14,
wherein the control section displays a display that shows whether either of the optical zoom processing and the electronic zoom processing is in progress.

17. The image pickup apparatus according to claim 14,
wherein when an operation of the first operation section is performed in a case where photographing of a moving image is not being performed, the control section displays a display for notifying that optical zooming can be performed by an operation of the second operation section.

18. An image pickup apparatus to which a fixed focal length lens that has a focusing operation section for controlling a focus lens can be detachably mounted, comprising:
a first operation section for controlling zoom processing; and
a control section that, when moving image photographing is not being performed, conducts electronic zoom control that changes a cut-out range of a picked-up image based on an operation of the first operation section and conducts focus control that controls the focus lens based on an operation of the focusing operation section, and when moving image photographing is being performed, conducts electronic zoom control that changes a cut-out range of a picked-up image based on an operation of the first operation section and the focusing operation section.

19. An image pickup apparatus, comprising:
a lens mount capable of selectively mounting a lens that has a zoom operation section and a lens that does not have a zoom operation section;
a switch that selects moving image photographing and still image photographing; and
a control section that, even when the lens that has the zoom operation section is mounted, when moving image photographing is selected by the switch, inhibits a zoom operation in response to an operation of the zoom operation section.

20. The image pickup apparatus according to claim 19, comprising a display section,
wherein the control section displays a warning on the display section when the zoom operation is inhibited.

21. An image pickup apparatus, comprising:
a lens mount capable of selectively mounting a lens that has a zoom operation section and a lens that does not have a zoom operation section;
a main body zoom operation section that is provided on an image pickup apparatus main body;
a switch that selects moving image photographing and still image photographing; and
a control section that, when the lens that has a zoom operation section is mounted, when moving image photographing is selected by the switch, conducts zoom control in response to an operation of the main body zoom operation section, and when still image photographing is selected by the switch, does not conduct zoom control in response to an operation of the main body zoom operation section.
